(19) United States
(12) Patent Application Publication
(10) Pub. No.: US 2026/0344555 A1
(43) Pub. Date: Nov. 5, 2026

(54) METHOD AND APPLICATION UNIT FOR APPLYING SEED DRESSING COMPOSITION, DRESSING APPLICATION DEVICE, SEED TUBE AND SOWING DEVICE

(71) Applicant: SYNGENTA CROP PROTECTION AG, Basel (CH)

(72) Inventors: Roger KARLEN, Kaiseraugst (CH); Lukas OBRIST, Kaiseraugst (CH)

(73) Assignee: SYNGENTA CROP PROTECTION AG, Basel (CH)

(21) Appl. No.: 19/488,482

(22) PCT Filed: May 27, 2024
(86) PCT No.: PCT/EP2024/064543

§ 371 Date: Nov. 26, 2025

(30) Foreign Application Priority Data
May 31, 2023 (EP) 23176431.7

(51) Int. Cl. A01C 1/06; A01C 7/04; A01C 7/06; A01C 7/10; A01C 7/20

(52) U.S. Cl. CPC A01C 1/06; A01C 7/04; A01C 7/06; A01C 7/105; A01C 7/206

(57) ABSTRACT

The invention relates to a method for applying a dressing composition to falling plant propagation materials (K), including: —detecting by a first sensor a freely falling plant propagation material; —determining a trigger time (ta) and triggering an applicator device (330) for discharging aliquots (D) of the dressing composition towards a predetermined material hit zone (T); —scanning by a second sensor a scan zone (A) where the plant propagation material is in free fall, within or around or after the hit zone; —judging, whether or not the plant propagation material (K) was hit by the aliquot. The invention also relates to a respective application unit (200), application device (130), sowing device (100), and seed tubes (210). The seed tubes include second sensor mounting means for mounting a second sensor arrangement (370) to cover the scan zone (A). The invention inter alia enhances a precision and reliability and controllability of dressing application.

The present invention relates to a method for applying seed dressing composition, an application unit, a dressing application device, a seed tube and a sowing device, allowing for enhanced precision and reliability of application.

### BACKGROUND OF THE INVENTION

Precision sowing machines are used in agriculture for introducing seed into the soil. They have small sowing coulters or ploughshares which form grooves with a depth of several centimetres in the arable soil. Plant propagation materials, such as seeds, which are kept in a reservoir container and fed to the separating element, are placed individually in these grooves or furrows. The furrows are then closed again by a refilling means which runs behind, for example by means of what is referred to as a harrow. Another possible application is to deposit microgranulates or pelletized seeds in the seed furrow. The advantage of these agricultural machines for sowing plant propagation materials is the precise and uniform depth positioning of the seed, which gives rise to less consumption by birds and to a more uniform field emergence compared with broad spreading in which the plant materials are distributed widely or randomly over the entire arable field.

In order to assist the growth of the crop, the use of seed dressings comprising chemical or biological substances is conventional practice in agriculture, in order to protect the seed and the seedling against fungi, bacteria and insects. In this context, the respective active substance or a combination of active substances is applied in the form of a coating directly to each individual seed. In addition to the actual active substances with a fungicidal, growth enhancing and/or insecticidal effect, the seed dressing also generally contains adhesive agents for improving the adhesion of the active substances to the seed as well as dispersants and colouring agents.

It is known for e.g. seeds to be treated centrally with what are referred to as seed dressings at the seed producers. Here, seed coating techniques area may be utilized to coat the seeds or agglomerations or pellets of seeds with the agriculturally useful substances using drum coaters, rotary coaters, tumbling drums, fluidized beds and spouted beds, via a batch or continuous coating process. Usually, the seeds are introduced into a coating machinery where they are contacted with a seed coating comprising one or more active ingredients and any other component. This is usually done in one or more layers whereby outer layers can be introduced sequentially to e.g. a rotating drum.

There are number of issues with the thus applied precoated seeds, in particular the formation, and, hence exposure of humans to dust produced during the process, and from the finished product in handling, shipping and sowing. Another issue is in the limit on shelf life for in particular biological or biosimilar active ingredients, and the inability to adapt the composition or combination of active ingredients to the conditions prevalent at the time of sowing. This is in particular relevant when coated seeds are handled by the farmer or farm operator, as unavoidable partial abrasion of the applied crop protection product occurs in the sowing machine during the sowing process owing to mechanical loads, as a result of which a fine seed dressing dust which is contaminated with active substances is produced. In particular in the now customary pneumatically operating precision sowing machines, in which in order to introduce the seed into the soil in a controlled way a partial vacuum or excess pressure can be applied to a separating element, this fine seed dressing dust is swirled up by the air stream of a blower and dispersed. In this context, the fine seed dressing dust can accumulate in the sowing machine, which can restrict the functional capability of the system and constitute a possible hazard for the operator of the system. However, the more or less uncontrolled escape of the seed dressing dust from the sowing machine into the surroundings is particularly problematic, which can constitute a hazard for people and animals, in particular for insects.

In view of the aforementioned issues of a pre-coating technique, the applicants have recently proposed methods and devices for applying seed dressing composition to plant propagation material, by applying or spraying or “shooting” aliquots of dressing to granular plant propagation materials in the form of a droplet or spray beam in free fall right at the moment of sowing. Herein, individual separated plant propagation materials are sensed by a sensor array, a fall line is calculated or estimated, and a dressing composition is applied by an outlet device including a nozzle coupled to an application valve which in turn is connected to a dressing container, along a spraying trajectory, depending on calculated intersection of the falling line with the spraying trajectory which determines an impact location. Such methods and devices may be found e.g. in WO 2021/032630 A1, WO 2021/032631 A1, WO 2021/032632 A1, WO 2021/032633 A1, WO 2021/032634 A1, and will be addressed hereinafter generally as aspects of a “high-precision seed treatment”.

A hit rate which is defined as a proportion of plant propagation materials actually being hit by a shot of dressing composition within a total number of plant propagation materials sown, may rarely be perfectly 100%. There may be reasons why an individual plant propagation material might not be hit by the dressing composition, including internal factors like calculation error, false assumptions, inaccurate initialization, internal variation in spray pressure, triggering delay, misalignment of parts which may be present from the beginning or emerging in the course of time, or external influences like climate, variation in seed. In order to ensure that plant propagation materials are reliably hit, it might be considered to increase volume of dressing, using a wider spraying angle, or providing more than one nozzle to enhance a hit rate.

### SUMMARY OF THE INVENTION

It is an object of the present invention to enhance a hit rate of a precision seed treatment. In particular, objects of the invention are to provide methods and devices for accurate, reliable, user-friendly, sustainable and versatile application of a dressing composition to plant propagation material during its falling from a separation device to an underlying surface, while reducing waste of chemical products, having simpler application gear and/or easier while reliable control, and reducing environmental impact.

The object is solved at least in parts by a method for applying a dressing composition having the features of independent claim 1, an application unit for applying a dressing composition having the features of independent claim 11, a seed tube having the features of independent claim 17, a dressing application device having the features of independent claim 18, and a sowing device having the features of independent claim 19.

One aspect of the invention is based on the general idea of detecting falling plant propagation material during shot or post-shot by an additional sensor, adjusting calculation of predicted trigger time when a fail rate which is defined to be an inversion of the hit rate is increasing or too high.

Accordingly, one aspect of the invention is a method for applying a dressing composition to plant propagation materials, preferably seed, in particular granular seed, preferably singulated by and released from a separating means of a sowing device and falling to an underlying surface, the method including:
detecting, by means of a first sensor arrangement, a plant propagation material which is freely falling within a predetermined detection zone;
determining, based on the detecting the plant propagation material, a trigger time for triggering a triggerable applicator device provided for discharging aliquots of the dressing composition towards a predetermined hit zone where the plant propagation material can be hit in free fall by the aliquots, the hit zone being preferably defined by a spraying trajectory of the dressing composition discharged from the applicator device;
triggering the triggerable applicator device at the determined trigger time to discharge an aliquot of the dressing composition towards the hit zone;
scanning, by means of a second sensor arrangement, a predetermined scan zone where the plant propagation material is in free fall, within or around or after the hit zone;
judging, based on a result of the scanning, whether or not the plant propagation material was hit by the aliquot, the result of the scanning preferably being a distance information.

A “free fall” as referred to herein is used in the sense of a falling onto an underlying surface by gravity, in contrast to a bound setting by some sowing manipulator manipulating a plant propagation material into the soil. As such, “free fall” includes the possibility that the plant propagation material may have contact to walls of a guiding means such as a seed tube.

A “hit zone” as referred to herein is a space where the aliquot of dressing composition is expected to impact onto the plant propagation material. It may in the simplest case be a point where a fall line of a plant propagation material crosses the spray trajectory of the applicator device.

A “scan zone” as referred to herein is a space where the plant propagation material is expected to be at or after or right before being hit by the dressing.

A “plant propagation material” as referred to herein is seed or dummy seed, in particular in granular form, maybe pelletized. In some embodiments, the method may be adapted to also be used with other plant propagation material like seedlings, cuttings or other bigger and irregularly formed material. It will be noted that any detecting, scanning, hitting, falling or any other event relating to a plant propagation material refers to one individual specimen of plant propagation material, unless indicated otherwise.

In some embodiments, the method further includes:
if the judging reveals that the plant propagation material was not hit by the aliquot: adapting a parameter used in determining a trigger time for a next plant propagation material.

In some embodiments, the determining the trigger time includes:
determining a time shift from detection of the plant propagation material until application of the dressing composition; and
calculating the trigger time as a sum of the time of detection and the time shift while applying a further variable addend and/or a variable factor by which the time shift or a monomial of a polynomial representing the time shift is multiplied, wherein the parameter includes the variable addend and/or the variable factor.

Herein, the determining the time shift may include at least one of:
determining a drop time of the plant propagation material from its detection until it arrives at the hit zone,
determining a flying time of the aliquot from its discharge by the applicator device until it arrives at the hit zone,
calculating the time shift by including the drop time and/or the flying time as addends, wherein the parameter preferably includes a variable factor by which the drop time and/or the flying time or a monomial of a respective polynomial representing the drop time or flying time are multiplied.

In some specific embodiments where the determining the time shift includes determining a drop time of the plant propagation material from its detection until it arrives at the hit zone, the determining the drop time includes:
determining a drop velocity of the detected plant propagation material; and
calculating the drop time of the plant propagation material based on the drop velocity and a distance between the detection zone and the hit zone.

Herein,
the detecting the plant propagation material may include detecting a first passing time of the plant propagation material passing a first location within the detection area, and detecting a second passing time of the plant propagation material passing a second location within the detection area, the second location being located downstream the first location along a falling direction of the plant propagation material, the first location and the second location preferably being cross-sectional areas or diameters across the falling direction of the plant propagation material; and
the drop velocity of the detected plant propagation material may be calculated based on the first passing time and the second passing time and a distance between the first location and the second location.

Alternatively, where a second passing time is dispensed from being detected, a drop velocity may be predetermined based on geometry and physics of motion.

In some specific embodiments where the determining the time shift includes determining a flying time of the aliquot from its discharge by the applicator device until it arrives at the hit zone, the determining the flying time includes:
determining a shot velocity of an aliquot of dressing composition discharged from the applicator device; and
calculating the flying time of the aliquot based on the shot velocity and a distance between a discharge opening of the applicator device and the hit zone.

Herein,
the detecting the plant propagation material may include detecting an offset of the plant propagation material detected in the detection zone; and
the determining the flying time may include calculating a predicted impact location of the plant propagation material within the hit zone based on the detected offset in the detection zone, and calculating the flying time based on the shot velocity and a distance between a discharge opening of the applicator device and the predicted impact location.

A “predicted impact location” as referred to herein is a location where the aliquot of dressing composition is expected to impact onto the plant propagation material. It may in the simplest case be a point where a fall line of a plant propagation material crosses the spray trajectory of the applicator device, or in more sophisticated cases a location calculated based on an initial detected offset.

In some embodiments, the judging includes.
determining a predicted time of hit or a predicted location of the plant propagation material after a hit as an expected result of scanning;
determining an detected time of hit or a detected location of the plant propagation material after a hit as an actual result of scanning, by evaluating the result of the scanning;
comparing the predicted time of hit with the detected time of hit, or the predicted location of the plant propagation material after a hit with the detected location of the plant propagation material after a hit as an actual result of scanning, to obtain a difference between the expected result of scanning and the actual result of scanning.

In some embodiments, the adapting includes.
statistically evaluating differences between expected results of scanning and actual results of scanning for a plurality of plant propagation material or over a predetermined time, and
deciding, based on the statistical evaluation, whether or not a significant shift has occurred; and
if the deciding is made to the affirmative, adapting the parameter, otherwise not.

The statistical evaluation may help overcoming two problems:
correction for a plant propagation material that is being treated right away is not possible, because processing is not fast enough, thus statistical evaluation allows for better prediction of necessary correction, and
the plant propagation materials fall in a gaussian or poisson distribution pattern, therefor making a judgment on a single plant propagation material might lead to noisy/jumpy control. Statistical evaluation across a number of plant propagation materials may help smoothing control. In this context statistics with a minimum of significance will be advantageous.

In some embodiments, the method includes machine learning, in particular for the adapting the parameter in the determining the trigger time.

In some embodiments, the method further including:
detecting whether or not the applicator device was actually triggered at the determined trigger time, and/or whether or not an appropriate aliquot of dressing composition was actually discharged after triggering; and
suppressing the scanning the scan zone and judging if it is detected that the applicator device was not triggered at the determined trigger time, and/or an appropriate aliquot of dressing composition was not discharged after triggering.

In some embodiments, plural seed detection sensors covering the detection zone are controlled in a serial fashion such that cross-detection may be avoided.

A further aspect of the invention is an application unit for applying a dressing composition to plant propagation material, preferably seed, in particular granular seed, falling during sowing, the application unit being formed to be mounted with a sowing device having separating means for singulating plant propagation materials supplied from a reservoir container and releasing the plant propagation materials to free fall, the application unit comprising:
a seed tube defining a falling space for the plant propagation materials, being formed to receive the plant propagation materials from the separating means, allow the plant propagation materials to fall through the falling space while optionally being guided by walls of the seed tube, and to further fall onto an underlying surface after leaving the seed tube;
a first sensor arrangement formed and arranged for detecting a plant propagation material falling within a predetermined detection zone within the falling space;
a triggerable applicator device formed and arranged for discharging an aliquot of a dressing composition received from a dressing composition supply, the applicator device having a discharge opening directed to a hit zone which is defined by an intersection of a spraying trajectory of dressing composition discharged from the applicator device with the falling space to hit the plant propagation material in free fall, the hit zone preferably being outside the seed tube, the applicator device having a triggerable application valve for opening or closing a fluid communication with the dressing composition supply;
a second sensor arrangement formed and arranged for scanning a predetermined scan zone where the plant propagation material is in free fall, within or around or after the hit zone in a falling direction of the plant propagation material; and
a control unit configured for controlling the first sensor arrangement to detect a plant propagation material falling within the detection zone and receiving output signals from the first sensor arrangement, determining a trigger time based on a detection time of the detected plant propagation material, triggering the applicator device to open the fluid communication path at the determined trigger time for a predetermined open time to discharge an aliquot of the dressing composition towards the hit zone, controlling the second sensor arrangement to scan the scan zone after triggering the applicator device, and judging, based on output signals received from the second sensor arrangement, whether or not the plant propagation material was hit or sufficiently hit by the aliquot.

It will be noted that the falling space includes an internal space enclosed by walls of the seed tube but may extend to a projection of a cross-section of the walls normal to the cross-sectional area outside (downstream) the seed tube.

A controlling respective sensor arrangements includes enabling/disabling respective sensors and receiving sensor signals.

In some embodiments, the first sensor arrangement includes a first sensor array of one or more seed detection sensors covering a first location within the detection zone and a second sensor array of one or more seed detection sensors covering a second sensor area within the detection zone, the second location being located downstream the first location along a falling direction of the plant propagation material, the first location and the second location preferably being cross-sectional areas or diameters across a longitudinal axis of the seed tube.

It will be noted that a longitudinal axis of the seed tube as referred to herein is a local axis which may be straight or curved, and is defined to follow local centroids of cross sectional areas of the seed tube.

In some embodiments, each seed detection sensor in the first sensor arrangement includes a laser light barrier, and the control unit is preferably adapted to control the seed detection sensors in the first sensor arrangement in a serial fashion. Here, the controlling the seed detection sensors includes enabling/disabling each seed detection sensor to send a laser beam and/or to receive a reflected laser beam at a same side of sending or an undisturbed laser beam on an opposite side of sending, as a whole or individually, in a continuous or pulsed fashion. The detection of a plant propagation may be effected where upon sending a laser beam, no reception of a laser beam is sensed.

In some embodiments, the second sensor arrangement includes a distance sensor, preferably an ultrasonic distance sensor, and the control unit is adapted to determine a presence and/or distance of the plant propagation material based on sensor signals received from the second sensor arrangement, and to judge based on the determined presence and/or distance of the plant propagation material whether or not the plant propagation material detected before by means of the first sensor arrangement was hit by the aliquot.

In some embodiments, the application unit further including an valve operation sensor formed and arranged for detecting an operating state of the application valve and/or a pressure sensor formed and arranged for detecting a fluid pressure of a fluid supply line for supplying the dressing composition to the applicator device, wherein the control unit is preferably adapted to judge, based on sensor signals received from the valve operation sensor, whether or not the applicator device was actually triggered at the determined trigger time, and/or to judge, based on sensor signals received from the pressure sensor, whether or not an appropriate aliquot of dressing composition was actually discharged after triggering, and in either negative case to skip the scanning and judging based thereon.

In some embodiments the control unit is formed and configured for controlling elements of the application unit and/or equipment external from the application unit to perform the method of the previously described aspect or any embodiment of the same.

A further aspect of the invention is a seed tube, in particular in the application unit described above, having a body for defining a falling space for a plant propagation material, preferably seed, in particular granular seed, the body having a receiving end with a receiving opening for receiving the plant propagation material from a separation means of a sowing device and a releasing end for releasing the plant propagation material after having fallen through the falling space, the body further having first sensor mounting means for mounting a first sensor arrangement to cover a detection zone defined within the falling space, in particular within the internal space of the body, applicator mounting means for mounting an applicator device to have a supply end to be connected to a fluid supply line and a discharge opening directed to a hit zone defined within the falling space and preferably outside the internal space of the body beyond the releasing end thereof, the body further comprising:
second sensor mounting means for mounting a second sensor arrangement to cover a scan zone defined within or around or after the hit zone in a falling direction of the plant propagation material.

A further aspect of the invention is based on the general idea of having a decentral control by a control unit on every seed tube, which allows for short signal paths, independent calculation, distributed computing load, low latency, resulting again in enhanced precision of measurement, processing, control and dressing application, thus in enhanced hit rate, and further allows for the control being easily adapted to different seeds on different seed tubes on a same sowing device which may support mixed cropping for enhanced fertility management, green manure, natural pest control, soil cover, enhanced micro-climate, and biodiversity. Seed tube having electronics compartment.

Accordingly, a further aspect of the invention is a seed tube, in particular in the application unit described above, having a body for defining a falling space for a plant propagation material, preferably seed, in particular granular seed, the body having a receiving end with a receiving opening for receiving the plant propagation material from a separation means of a sowing device and a releasing end for releasing the plant propagation materials after having fallen through the falling space, the body further having first sensor mounting means for mounting a first sensor arrangement to cover a detection zone defined within the falling space, in particular within the internal space of the body, applicator mounting means for mounting an applicator device to have a supply end to be connected to a fluid supply line and a discharge opening directed to a hit zone defined within the falling space and preferably outside the internal space of the body beyond the releasing end thereof, the body further comprising:
electronics mounting means for mounting a control unit for controlling the first sensor arrangement and/or the applicator device and/or the second sensor arrangement.

A further idea is that the seed tube has adapted pipe geometry for ensuring that seed remains in a center thereof, for enhancing precision of dressing application, and also reducing number of sensors in a sensor array.

Accordingly, in some embodiments, the seed tube further comprises a guiding channel formed by the body between and including the detection zone and the release end, the guiding channel having a width at least in one cross-sectional direction which is adapted to a grain size of a particular type of plant propagation material.

A further aspect of the invention is a dressing application device having a plurality of application units as described above, wherein at least part of the control units of each application unit is provided in a distributed fashion in each application unit, in particular mounted to the respective seed tube of each application unit, the seed tubes being preferably formed as above.

In embodiments, the dressing application device has at least one of:
a power supply;
a dressing reservoir for fluidized dressing composition; and
piping for communicating respective applicator devices of each application unit with the dressing reservoir.

A further aspect of the invention is a sowing device having a reservoir container for carrying plant propagation materials, preferably seed, in particular granular seed, separating means for singulating individual plant propagation materials from the grain reservoir and releasing the singulated grains to allow the singulated grains to fall onto an underlying surface, one of more of application units as described above, or a dressing application device as described above, each application unit being formed and mounted to receive singulated grains released from the separating means at a receiving end of a respective seed tube.

Further objects and advantages of the present invention will now become apparent from the following description of preferred embodiments of apparatus for carrying out the method, as particularly illustrated in the accompanying drawings which form a part of this application. It is obvious that the invention is not limited to the embodiments described above and shown in the accompanying drawings. Modifications remain possible, in particular as regards the constitution or the number of the various elements or by substitution of technical equivalents, without departing from the scope of protection as defined by the following claims. It will further be noted that, and any features described with respect to any aspect or embodiment thereof, may be used in any other aspect or embodiment thereof, as far as feasible.

### BRIEF DESCRIPTION OF DRAWINGS

The invention will now be described in further detail referring to specific exemplary embodiments which are shown in the appended drawings. In the drawings,

FIG. 1 is a schematical overall illustration of a sowing device according to an embodiment of the invention;

FIG. 2 is a schematical block diagram of a dressing application device in the sowing apparatus according to an embodiment of the invention;

FIG. 3 is a schematical view of an application unit in the dressing application device according to an embodiment of the invention;

FIG. 4 is a logical diagram for controlling the application unit according to an embodiment of the invention;

FIG. 5A is a schematical perspective view of a seed tube in the application unit according to an embodiment of the invention;

FIG. 5B is a schematical front view of a detail “B” in FIG. 5A.

It will be noted that any drawings are of schematical nature. This means that, unless indicated or obviously otherwise, geometric dimensions and relations may be exaggerated for the purpose of illustrating an underlying principle, rather than specific constructive details.

In the following description, all the positional information and directional information, such as e.g. top, bottom, above, below, upwards, downwards, vertical, horizontal, etc. relate to the upright position of the sowing device according to the invention as illustrated in the figures and corresponding to their practical use.

### DETAILED DESCRIPTION OF EXEMPLARY EMBODIMENTS

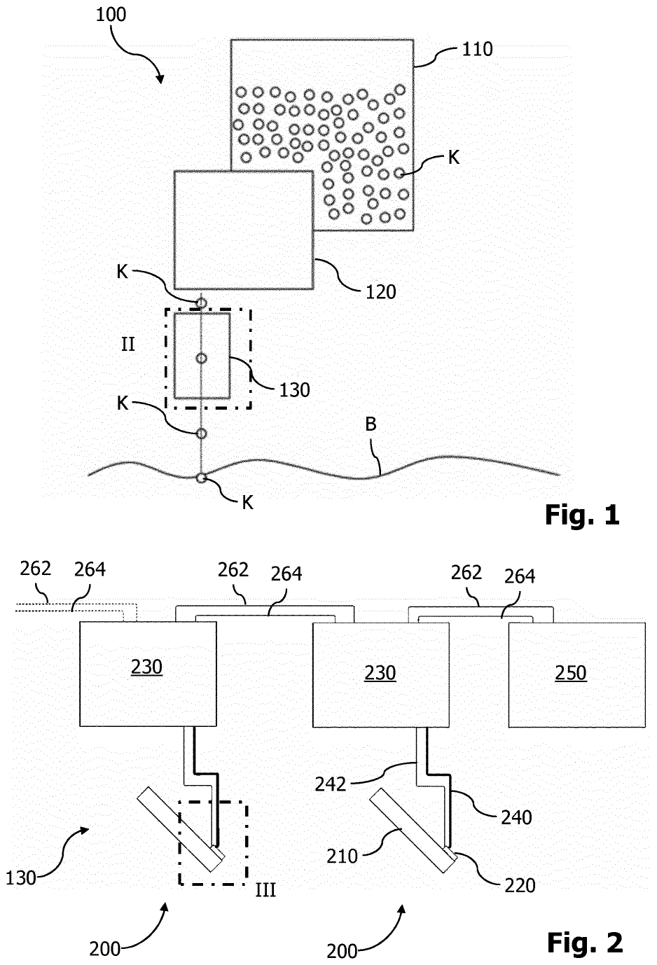

According to the overall view in FIG. 1, the sowing device 100 comprises a reservoir container 110 for plant propagation material K, depicted herein as granular seed, a separating device 120 which is designed to separate plant propagation materials K fed from the reservoir container 110 and to output them individually, and an application device 130 for applying seed dressing to the plant propagation materials K which are output individually by the separating device 120. The application device 130 is designed and arranged here in such a way that it can apply seed dressing to the separated plant propagation materials K after they leave the separating device 120 during their falling movement onto an underlying surface B for seed.

The entire sowing device is usually mounted during practical use on an agricultural vehicle such as e.g. a tractor. In some embodiments, the sowing device or parts thereof may be mounted on a trailer pulled by an agricultural vehicle such as e.g. a tractor. Driven parts of the sowing device may be coupled with a motor output shaft of the vehicle. In this context, a sowing device can include several sowing units be arranged on the vehicle, with the result that seed can be discharged simultaneously into a plurality of seed furrows. The seed devices can, of course, also be applied with a common reservoir container here.

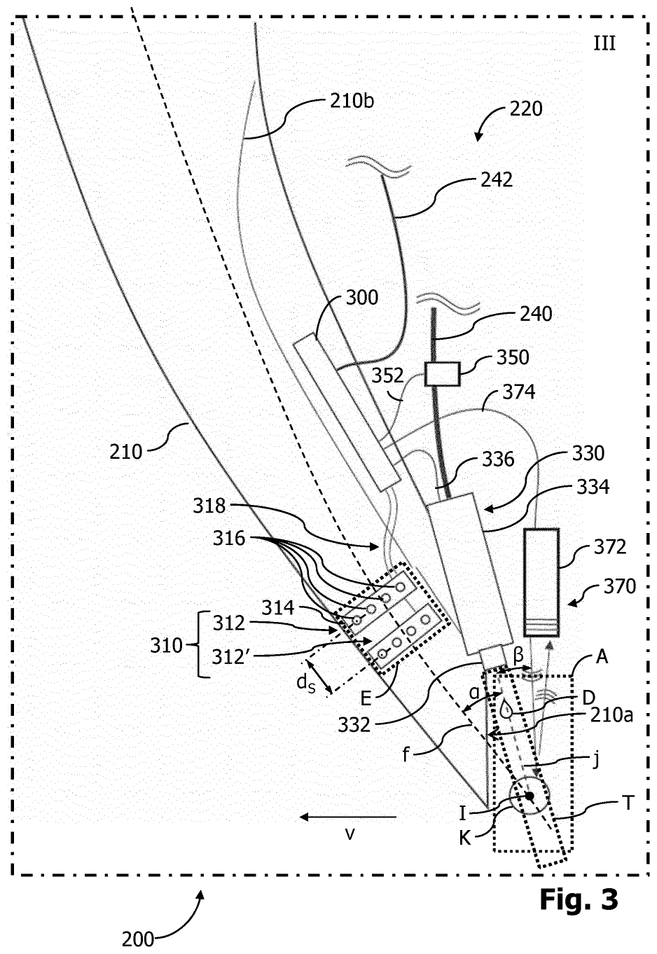

According to the diagram in FIG. 2, the application device 130 may include several application units 200, each of which may be associated to a particular sowing unit of the application device 130, and a supply unit 260.

Each application unit 200 includes a seed tube 210, an application functional block 220, and an interface unit 230. The seed tube 210 is formed and arranged to receive PPM K from separation device 120 at an upper end, to enclose and/or define a fall line f of the PPM K, and to release the PPM K at a lower end 210a (see FIG. 3). Here, in particular, the seed tube 210 may be arranged below an output opening of the separation device 120.

The application functional block 220 includes a sensor system and application nozzle (not shown here) as will be described later. Each interface unit 230 includes a unit communication module, a seed tube control means and a liquid supply. The liquid supply of the interface unit 230 is connected with the application nozzle of the application functional block 220 via an application supply line. The seed tube control means is connected with the sensor system of the application functional block 220 via an electric cabling 242.

The supply unit 250 includes an electric supply module such as a battery, battery charger, battery management system, and a pneumatic supply, a device communication module, a pneumatic supply module, and a device control module. The electric supply module is connected to the interface units 230 of each application unit 200 via an electric cabling 262. The device communication module may be connected to the unit control modules of the each application unit via the electric cabling 262 or wireless. In some embodiments, the electric cabling 262 includes a main cabling to one of the interface units 230 and interconnection cabling from the one of the interface units 230 to another interface unit 230, and so on, to form a chain connection from interface unit 230 to interface unit 230. In other embodiments, the electric cabling 262 includes separate cablings to each interface unit 230. In still other embodiments, the electric cabling 262 includes a daisy-chain cabling.

The pneumatic supply of supply unit 250 is connected to the interface unit 230 of each application unit 200 via pneumatic supply line 264. In some embodiments, the pneumatic supply line 264 includes a pneumatic main line to one of the interface units 230 and pneumatic interconnection lines from the one of the interface units 230 to another interface unit 230, and so on, to form a chain connection from interface unit 230 to interface unit 230. In other embodiments, the pneumatic supply line 264 includes separate parallel pneumatic lines to each interface unit 230. In still other embodiments, the pneumatic supply line 264 includes a pneumatic manifold or distribution hub having one end connected to the pneumatic supply of the supply unit 250, and several ports connected to each interface unit 230. The pneumatic supply is for operating a separating element for seed associated to each application unit 200. In embodiments, the pneumatic supply is also used for providing a predetermined pneumatic pressure for pressurizing the liquid supply of each interface unit 230.

In some embodiments, each application unit 200 includes a cartridge or canister configured to hold a dressing composition or seed coating composition or solution including one or more active ingredients until release of the composition from the canister. Such canister is in fluid communication with an application nozzle configured to release the composition from the canister. In some embodiments, two or more canisters are operatively coupled in fluid communication to a single application nozzle, such that the single nozzle may be controlled (e.g., by the control unit or the control unit of the computing device) to selectively spray a seed coating from any one of the canisters coupled to the nozzle. In other embodiments, two or more cartridges may each be operatively coupled in fluid communication to their own respective nozzles such that each canister only sprays its respective composition only via its own respective nozzle.

In some embodiments, the supply unit 250 may include a common liquid supply system which includes one or more liquid containers, and one or more liquid supply lines per liquid container for distributing a dressing composition to each application unit 200. In this case, each application unit 200 may receive a dressing composition from the supply unit via a main line or an interconnection line or a manifold communicating with the supply unit 250. Further in this case, the liquid container may be pressurized at the supply unit 250. However, each application unit 200 may also have a separate pressurizing means for controlling application pressure of the dressing composition.

In some embodiments, a supply device may be provided externally or internally of the application device, preparing an individual dressing composition from a plurality of bulk containers each storing a bulk agricultural composition, said bulk agricultural compositions preferably being commercially available or prepared in advance, the individual dressing composition being prepared in batches on the run from a bulk agricultural composition or two or more bulk agricultural compositions and optional carrier liquid or solvent or diluent, according to actual needs based on one or more criteria including, but not limited to, environment, climate, season, kind of plant propagation materiel, type of soil, location, pest load, and other information, previously stored or acquired just in time from a management system and/or remote, i.e., internet, mobile, satellite sources, and feeding the prepared batches of individual dressing composition(s) to the application device 130 or each application unit 200.

FIG. 3 shows a detail of an exemplary application unit 200 in the application device 130 of FIG. 1 or 2 according to an embodiment in a schematic illustration. In this example, the application unit 200 is for treatment of plant propagation material K with a seed dressing composition.

The application unit 200 comprises the seed tube 210 and the application functional block 220.

The seed tube 210 includes a tube wall having an upper end (not shown) and a lower end 210a. The seed tube 210 serves to guide separated seeds K falling from the separator along a fall line f. The seed tube 210 has a certain shape which will be described later as an exemplary embodiment of the invention. Here, the seed tube 210 has a bent shape as seen from the side and is oriented obliquely but may also be oriented vertically during practical use and is open at a top end and bottom end 210a. Otherwise, the tube wall 232 is generally closed and defines an interior space.

The application functional block 220 includes a seed tube sub-controller 300, a first sensor arrangement 310, an applicator device 330 for seed dressing, a pressure sensor 350, and a second sensor arrangement 370.

The seed tube sub-controller 300 is received in a mounting bay 210b formed as a recess in a wall of the seed tube 210, and coupled with the interface unite 230 via electronic control cabling 242.

The first sensor arrangement 310 includes two sensor arrays 312, 312′ attached to a wall of the seed tube 210 to cover a detection zone E inside the seed tube 210, to detect a plant propagation material K falling along the fall line f. The sensor arrays 312, 312′ are located along respective cross-sections having a distance dₛ from each other. Each sensor array 312, 312′ has a sensor casing 314 carrying a number of seed detection sensors 316. The first sensor arrangement 310 is connected to the seed tube sub-controller 300 by a seed sensor control line 318.

Each sensor array 312, 312′ in this example includes four individual seed detection sensors 316. The seed detection sensors 316 of each sensor array 212, 212′ may by way of example be formed as laser optical sensors each including a laser emitter and a laser detector, but may also be formed in any other applicable type. Suitable sensors are known in the art and therefore do not require any more detailed explanation. The individual seed detection sensors 316 may be activated by seed tube sub-controller 300 or by some sensor logic built in with each sensor array 312, 312′ or the first sensor arrangement 310 as a whole, in a serial fashion such that each seed detection sensor 316 will only be triggered by a reflected laser beam emitted by its own but will ignore any reflected laser beam emitted by any other seed detection sensor 316. After the lower sensor array 312′ has detected a seed propagation material K, it may be set to idle until the upper sensor array 312 has sensed a next seed propagation material K to avoid misdetection. Moreover, as soon as a seed propagation material K has been detected to have passed a sensor array 312, 312′, this particular sensor array 312, 312′ may be set to idle for some time to avoid sensor artefacts.

Any of the seed detection sensors 316 of a sensor array 312, 312′ may detect the passage of the plant propagation materials K through the seed tube 210, and generate a pulse-shaped sensor signal if a seed K falls through its respective detection range. From the known position of the first sensor arrangement 310, the known distance dₛ and the passing times of a seed K sensed by each sensor array 312, 312′, an impact time where seed K falling along the fall line f passes a spraying trajectory j of the spray nozzle 240 can be predicted, and application valve AV1 of the spray nozzle 240 may be triggered to hit the seed K at an impact location I. Judging from which one of the sensors 316 notices passage of the seed K, the actual fall line f can be estimated, and the impact location I be predicted with more precision.

In some embodiments, each sensor array 312, 312′ may be addressed as a whole, e.g. as SA1, SA2. In other embodiments, each individual sensor 316 may be addressed individually, e.g. as SA1a-SA1d, SA2a-SA2d. Outputs of the first sensor arrangement 310 are output via seed sensor line 318 and processed by seed tube sub-controller 300. In embodiments, outputs of individual sensors 316 may be processed or pre-processed by some sensor logic built in with the first sensor arrangement 310 or each sensor array 312, 312′.

In some embodiments, the lower sensor array 312′ is omitted so that control relies only on upper sensor array 312 and feedback sensor 370 to be described later. In some embodiments, the number of individual seed detection sensors 316 may be more than four, may be more than one row, or may be less than four, e.g. three, two, or only one, depending on the particular shape of the seed tube 210 and its ability to precisely guide an individual plant propagation material.

The applicator device 330 includes an application nozzle 332 and an application shutoff valve 334 which is connected to seed tube sub-controller 300 via applicator control line 336, so that the application shutoff valve 334 may be controlled to open and/or close, by seed tube sub-controller 300. The applicator device 330 is communicated to the interface unit 230 via application supply line 240, to be supplied with seed dressing composition. By opening the application shutoff valve 336, the applicator device 330 may be triggered. The applicator device 330 is designed to eject through application nozzle 332, each time it is actuated or triggered, a predefined quantity of seed dressing of typically of from 0.1 to 30 μl, preferably of from 0.3 to 15 μl along an essentially linear spraying trajectory j, therefore as it were to output a “shot of seed dressing”. A falling plant propagation material D may be hit within a hit zone T which extends along the spraying trajectory j of the application nozzle 332.

Suitable application nozzles include corundum, ceramic or hard alloy nozzles. The application nozzle 332 can be embodied in such a way that it permits essentially droplet-shaped application of the seed dressing to a respective seed in each application process. Essentially droplet-shaped application is to be understood as meaning here an application of seed dressing which does not necessarily completely surround the seed but may cover only a relatively small (“punctiform”) or relatively large part of the surface of the seed. The same apparatus also allows to change nozzles and/or other parts for the application of other volumes and/or dressing viscosities, for instance. The seed dressing may typically be expediently configured in such a way that it adheres as droplets to the seed without a loss of spray, and dries, without in the process losing its adhesion. The application shutoff valve 334 may be embodied as a solenoid valve. In other embodiments, the application shutoff valve 334 may be embodied as a pneumatically driven application valve, in which case a pneumatic pressure line would be provided for controlling the application shutoff valve 334. It is therefore possible for valves for contactless micro-dosing to be used which are closed in the position of rest and can be switched by electro-pneumatic drive with opening times of less than 1 ms. Such valves generally have high dosing frequencies and very high dosing accuracies, as a result of which an extremely precise and reproducible dosing process is ensured. Other possible valves include solenoid valves, piezo valves and the like.

FIG. 3 illustrates an impact location I which is defined by the intersection point of the fall line f of the plant propagation materials K and the spraying trajectory j of the application nozzle 332. The application nozzle 332 is oriented in such a way that its spraying trajectory j intersects with the fall line f of the plant propagation materials K at an acute angle α of approximately 30°-60°. The impact location I is outside or underneath the seed tube 210 here. A “shot of seed dressing” is output when a seed K reaches the impact location I. This is the case, according to a spatial distance between the first sensor arrangement 310 and the impact location I and the rate of fall of the plant propagation materials K, after a certain time delay after the sensing the seed K according to a passing velocity calculated from a time distance of detection by sensor arrays 312, 312′ and their distance dₛ. The seed tube sub-controller 300 calculates (or estimates) the time delay and then outputs a trigger pulse which triggers the applicator device 330, i.e., opens application valve 334, and brings about the outputting of a “shot of seed dressing”, which then applies seed dressing to the seed which is located at the impact location I right at that time. The time delay also takes into account the system-inherent response time of the application valve 334 and the virtually negligible flight time of the seed dressing from the application nozzle 332 to the impact location I.

In embodiments, the seed tube 210 of the application device has a relatively narrow shape and has a funnel-shaped attachment. This has the effect that all the plant propagation materials K within the seed tube 230 move on the same fall lines for on fall lines f which are located very close to one another, with the result that the impact location I is virtually the same for all the plant propagation materials.

However, the plant propagation materials K can also be positioned in some other way on almost the same fall line or at least on fall lines which are located close to one another. For example, by means of air pressure or electrostatic forces or by means of a seed tube which is shaped otherwise, e.g. in the manner of a funnel. When electrostatic forces are used, the electrostatic charge of the plant propagation materials which arises in this context may have a positive effect on the adhesion of the seed dressing, similar to powder coating technology.

The pressure sensor 350 is located at the application supply line 240 to detect a supply pressure prevailing therein, and is connected with seed tube sub-controller 300 via pressure sensor control line 352. The detected supply line pressure may influence a speed of droplet D ejected from application nozzle 332, and thus may be a parameter to be taken into account when calculating or estimating an impact time and/or impact location I.

The second sensor arrangement 370 includes a feedback sensor 372 which is installed at the seed tube 210, to scan a scan zone A to detect whether or not the plant propagation material K was hit by a droplet D of seed dressing composition. The feedback sensor 372 is connected with seed tube sub-controller via a feedback sensor control line 374. The scan zone A is defined within or around or after the hit zone T.

The feedback sensor 370 may be embodied as an ultrasonic sensor, in particular distance sensor, having an ultrasonic emitter to emit ultrasonic waves, and an ultrasonic receiver to receive ultrasonic waves reflected from the area scanned, the ultrasonic emitter and ultrasonic receiver directed to the scan zone A. The feedback sensor 370 is arranged to emit ultrasonic waves in a direction having an acute angle β with the spraying direction of the application nozzle 332, and is formed to receive reflected ultrasonic waves from the scan zone A.

In embodiments, the second sensor arrangement 370 may include more than one feedback sensor 372 to scan the scan zone A, or to scan different parts of the scan zone A.

Based on a result of scanning by the feedback sensor 372, which result is provided to the seed tube sub-controller 300 via feedback control line 374, it can be judged whether a plant propagation material K was hit or not by an aliquot of dressing composition. By that feedback, a timing of triggering the applicator device 330 to eject a shot of seed dressing, can be adapted.

It will be noted that any electric lines 242, 318, 336, 352, 374 may be designed to provide electric power for operation of any electrically operated parts of the application functional block, as well as to transmit electrical signals, i.e., control signals and/or sensor signals, in one or two directions, respectively.

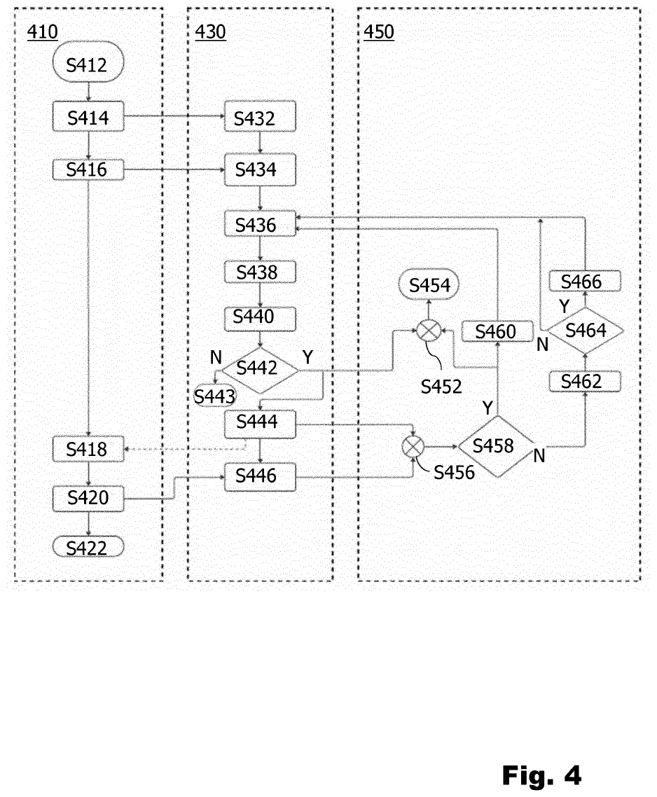

FIG. 4 illustrates a method for applying a dressing composition using the application unit 210 as exemplified in FIGS. 2 and 3 while adapting rigger times for the applicator device 330 in more detail, according to a preferred embodiment.

The method in this embodiment is illustrated by means of a seed tube event series 410 including events a seed undergoes while falling through the seed tube 210 and beyond, a control logic 430, and a feedback logic 450 which may occur be or executed in parallel. For the following description, a plant propagation material K will be exemplified as a seed.

At step S412, a seed falls through the seed tube 210. It will be noted that at this time, it is assumed that at least the upper sensor array 312 is enabled for detection while the lower sensor array 312′ may be held disabled from detection. Alternatively, the lower sensor array 312′ may also be enabled.

At step S414, the seed K passes the upper sensor array 312 which is detected by any of the seed detection sensors 316 of the upper sensor array 312, and a signal indicating that detection is sent to sub-controller 300. Here, in step S432, a first seed passing time t1 of the seed K is recorded by the control logic 430. At that time, in case the lower sensor array 312′ was disabled before, it is set to be enabled. Optionally at that time, the upper sensor array 312 may be set to be disabled until the seed K is detected to have passed the lower sensor array 312′ or a predetermined idle time has gone by.

At step S416, the seed K passes the lower sensor array 312′ which is detected by any of the seed detection sensors 316 of the lower sensor array 312′, and a signal indicating that detection is sent to sub-controller 300. Here, in step S434, a second seed passing time t2 of the seed K is recorded by the control logic 430. At that time, in case the upper sensor array 312 was disabled before, it is set to be enabled again. Optionally at that time, the lower sensor array 312′ may be set to be disabled until a further seed K is detected to have passed the upper sensor array 312 or a predetermined idle time has gone by.

Now, in step S436, a time shift Δta is calculated which is a time until application, and the control logic 430 waits for a time corresponding to the time shift Δta. The calculation of time shift Δta in the first place takes into account a velocity of the seed K calculated by a time difference between seed passing times t2, t1 and the distance dS between the sensor arrays 312, 312′, and a distance between the detection zone E (in particular, a cross-sectional plane covered by the lower sensor array 312′) and the hit zone T (in particular, a cross-sectional plane or oblique plane corresponding to the spraying trajectory j), to obtain a basic value of the time shift Δta. Parameters for adapting the time shift Δta based on results of the feedback sensor 370 will be taken into account as provided by steps S460, S466, which will be described later on.

After calculating the time shift Δta in step S436, step S438 follows for the control logic 430 to wait for the calculated time shift Δta.

Thereafter, in step S440 which corresponds to an application time ta, the applicator device 330 is triggered to eject a predetermined amount of dressing composition in the form of droplet D. To this end, the application time ta may also considered to be a trigger time. The applicator device 330, in particular an opening sensor in an opening mechanism of application valve 334, may report its activation back to the sub-controller 300, which however is optional.

A flow of dressing composition may be sensed by monitoring the pressure sensor 350, and will be recorded accordingly. In step S442 it is judged whether or not a flow of dressing composition has been registered, and in the negative case will result in skipping any further control for the present seed by branching off to step S443, which means that control returns to the beginning for a new seed. Optionally in step S443, failure in sensing a flow of dressing composition upon triggering may be recorded, and a counter may be started or continued on such failures while after a certain threshold of “non-shots” an alarm may be triggered to an operator.

On the feedback logic 450 side, the affirmative judgement in step S442 about recording of a flow of dressing composition is recognized in step S452.

Further on the control logic 430 side, a flying time tf is obtained in step S444, representing a time a droplet D needs from the application nozzle 332 to the impact location I to hit the seed K. Here, theoretical variations in the flying time tf due to pressure fluctuations are negligible in view of the small distance travelled by the seed and are therefore not taken into account, but could so if needed. Also, possible shift of fall line f or other influences on the impact location I are not considered relevant but could be taken into account if needed.

In the meantime, on the seed tube side 410, the seed K is hit or is not hit by the droplet D at step S418.

Then, at step S420, the seed K passes the second sensor arrangement 370 which is detected by the feedback sensor 372 of the second sensor arrangement, and a signal indicating that detection is sent to sub-controller 300. Here, in step S446, a feedback sensor passing time tfs of the seed K is recorded by the control logic 430.

The flying time tf from step S444 and the feedback sensor passing time tfs from step S446 are collected at step S456 on the feedback logic 450 side.

In step S458, it is judged whether a calculated hit time which is a sum of the application time ta and the flying time tf coincides with the feedback sensor passing time tfs: ta+tf=tus? In the affirmative case (branch “Y” from step S458), this is recognized in step S452 again, leading to the assumption in step S454 that the seed K was actually hit by the dressing composition. Further in the affirmative case, it is decided in step S460 that no change for Δta is necessary, and this information is provided to step S436 on the control logic 430 side where no change to Δta is made. In other words, a parameter for adjusting Δta is left unchanged.

In the negative case (branch “N” from step S458), feedback control 450 proceeds to step S462 where differences between the calculated hit time ta+tf and the recorded feedback sensor passing time tfs are summed up in statistics. A statistical evaluation could for example involve a histogram based on potential ta shifts. Then, the correction could be added towards the histogram bucket with the highest sum.

In step S464, a shift in recorded feedback sensor passing times tfs with respect to the calculated hit time ta+tf is evaluated, and if a significant shift is judged to have occurred (affirmative branch “Y” in step S464), a parameter for adjusting the time shift Δta is calculated in step S466 and provided to the calculation step S436 at the control logic 430 side. It will be noted that the updated parameter for adjusting the time shift Δta will have effect only for upcoming seeds K but not for the current seed K. In the negative case (“N” branch) in step S464, step S466 is skipped, leaving the parameter for adjusting the time shift Δta unchanged. Again, if failures of hit become to frequent, an alarm may be triggered to an operator.

On the seed tube side 410, after passing the second sensor arrangement 370 at step S420, the seed K, ideally treated with dressing composition, falls to the underlying surface B in step S422.

The whole process is of course repeated continuously for any seed K sensed during all a sowing campaign.

The feedback control described above greatly enhances precision of treatment of plant propagation materials by a dressing composition, by allowing for adapting to circumstances influencing the falling of seed K or flying of droplets D during a sowing campaign.

It will be noted that the method described above may be executed by any control means. In embodiments, the method is executed by the seed tube sub-controller 300. To this end, the seed tube sub-controller 300 receives and processes any signals from the first sensor arrangement 310, pressure sensor 350, second sensor arrangement 370, and optionally from some actuation feedback sensor included in the application shutoff valve 334, and provide control signals for enabling the upper and lower sensor arrays 312, 312′, controlling the feedback sensor 372, and triggering the application shutoff valve 334 of applicator device 330. The placement of a dedicated seed tube sub-controller 300 right at the seed tube 210 greatly reduces wiring lengths, thereby minimizes signalling delays to enhance precision of control, and also contributes to providing stabilized operating voltage.

In embodiments, the seed tube sub-controller 300 may be adapted to collect any sensor data and send the same to a higher-level control located at an instance such as a respective interface unit 230 or the supply unit 250 or even a remote management system, and receive control commands from such higher-level control.

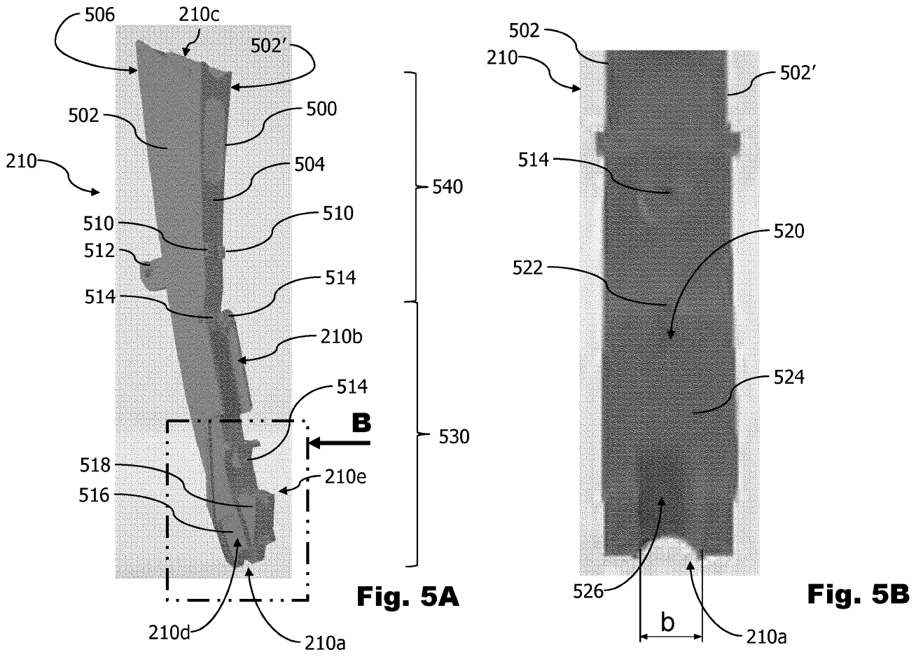

FIGS. 5A and 5B show a seed tube 210 as a further embodiment of the invention. Here, FIG. 5A is a perspective view of the seed tube 210 as a whole, and FIG. 5B is a front view of a detail B in FIG. 5A.

As seen in FIG. 5A and FIGS. 5B, the seed tube 210 has a main body 500. The main body 500 is generally formed by two side walls 502, 502′, a front wall 504 and a back wall 506. The side walls 502, 502′, front wall 504 and back wall 506 enclose a tube-like interior having an open lower end 210a and an open upper end 210c.

Several mounting elements 510, 512 are formed at the main body 500, for mounting the seed tube 210 to a frame of a sowing device or application device, or for fixing elements of the application functional block 220 such as lines 242, 240 to the main body 500.

The main body 500 may generally be divided into an upper part 540 and a lower part 530. In the upper part 540, the side walls 502, 502′, front wall 504 and back wall 506 define a generally funnel-shaped interior space while in the lower part 530, the interior space is of generally equal cross-sectional shape and area. For example, the interior space of the seed tube 210 may have a circular cross-sectional shape in the lower part 530 of the main body.

In the present example, the mounting bay 210b is formed in the lower part 530 by front wall 504 and wall sections extending therefrom, and may be closed by a lid to be fixed by screws or pins held in mounting bores 514. Thereby, the seed tube sub-controller 300 (see FIG. 3) can be sealed within the mounting bay 210b.

Further in the lower part 530 of the seed tube 210, preferably near its lower end 210a, a first sensor mounting area 210d is formed in the side walls 502, 502′. At the sensor mounting area 210d, the side walls 502, 502′ may be transparent at least to laser light of the sensors 316 so that through holes for letting pass sensor beams can be avoided. This may also avoid sensors (in particular, sensor optics) to be soiled which may contribute to accuracy and reliability of sensor results. In alternative embodiments, the whole seed tube 210 may be made of transparent material for the same reason. The sensor mounting area may include a recess 516 in each side wall 502, 502′ for securely supporting the sensor casings 316 (see FIG. 3).

Further in the lower part 530 of the seed tube 210, in particular near its lower end 210a, a nozzle mounting area 210e is formed by a socket 518 extending from the front wall 504. A bore 520 is formed in the socket 518 for receiving at least part of application nozzle 332, and/or forming a shooting channel for a shot of dressing composition. A mounting bore 522 is provided for securing the application nozzle 332, or the whole applicator device 330.

The socket 518 also provides a ramp 524 which is a surface for supporting the feedback sensor 372 under the sensor angle β. The shape of the socket is designed to securely supporting the application nozzle 332/applicator device 330 and the feedback sensor 372 by respective structural elements.

The interior space of the seed tube 210 forms a guiding channel 526 for the plant propagation material. A width b of the guiding channel 526 in the lower part 530 is generally dimensioned in relation to an average size (average value of a greatest dimension) of a particular plant propagation material, preferably a seed, in particular granular seed, which the seed tube 210 is made for. In other words, the seed tube 210 is adapted to a particular plant propagation material or a particular group of plant propagation material or a particular size class of plant propagation material. The width b be may for example dimensioned to be smaller than 3 times the average size of the particular plant propagation material. In embodiments, the width b be may for example dimensioned to be smaller than 2.5 times the average size of the particular plant propagation material. In embodiments, the width b be may for example dimensioned to be smaller than 2 times the average size of the particular plant propagation material. In embodiments, the width b be may for example dimensioned to be smaller than 1.5 times the average size of the particular plant propagation material. The dimensioning ensures that always at least a part of the plant propagation material is in the middle of the interior space of the seed tube 210. It e.g. allows that the seed will not considerably deviate from an average fall line and will therefore reliably be hit by a shot from the applicator device 330.

At the lower end 210a of the seed tube 210 the guiding channel 526 of the seed tube 210 is optionally cut lengthwise at the front wall 504. This allows for the seed K being enclosed between and guided by the side walls 502, 502′ and back wall 506 while being shot at by the applicator device 330, and/or detected by feedback sensor 372. This may e.g. further enhance hit rate and/or detection accuracy/reliability.

As used herein, the term an “underlying surface” is understood to be an agricultural soil or other solid medium onto which the plant propagation material, such as seeds and seedlings, are applied.

The term “plant propagation material” herein may refer to any seed, seedling, tuber, stem cutting or otherwise useful material for growing and propagating plants or crops. Many plant species, such as several fruits and ornamental plant species, are commonly reproduced by vegetative propagation (or “clonal propagation” or “vegetative reproduction”). Preferably it may refer to seeds, which are usually composed of individual plant propagation materials. The term “plant propagation material” is understood to denote all the generative parts of the plant, including but not limited to seeds, which can be used for the multiplication of the latter and vegetative plant material such as cuttings and tubers, for example, potatoes. There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. A preferred plant propagation material is the seed. In an aspect of the present invention, these young plants and generative parts may be protected before transplantation by a partial treatment, for example, by application of a dressing composition, according to the present invention. The term “seed” to be treated with the compositions of the present invention means a plant body of the initial stage of cultivation used for reproduction of plants, and involves not only the so-called seeds but also plant bodies for nutrient reproduction such as bulb, tuber, seed tuber, aerial tuber, scaly bulb, stalks for cuttage, and the like. The term “seeds” herein may be granular seeds, pelleted granular seeds, dummy seeds or combinations thereof.

Advantageously, “dummy seeds”, i.e. particles that are not plant propagation materials may be sown and treated alongside the actual seeds. Such “dummy seeds” may be useful in e.g. spacing apart smaller seeds or may be specifically sowed to carry phytotoxic dressing in e.g. rows parallel and spaced apart from rows of seeds, or fertilizers and growth enhancers to improve the soil quality.

Yet further, where plant propagation materials are employed that are very small, or irregular in shape and weight, these may be difficult to sow in regular distribution with a single seedling per cell, and with a straight row. Accordingly, there may be a number of erroneously planted seeds, and hence some cells will have more than one seed, while others, none. With high seed costs and largely for automated harvesting, it is not desirable simply place multiple seeds per cell, and then remove them to allow only a single plant in due time. Applicants have found that beneficially, seeds or propagation materials in general may then be put through a process called “pelleting”, wherein preferably an inert material is coated onto the seeds, thereby forming a more regular and uniform shape and size, e.g., wherein smaller seeds are pelleted to a specific size and shape suited for the planting and/or sowing process, e.g. to a standardized size and shape, e.g. adapting for instance tiny Petunia seeds to be useable in the same apparatus as lettuce seeds. The thus pelleted seeds have several benefits, including easier use of standardized equipment, a more regular spread of the seeds, and a higher rate of selective coating with the dressing composition. This in turn may reduce the need for thinning of fields, and easier automation in greenhouse applications seed starting. Preferably, the pelleting material used on the seeds is selected to absorb water quickly, ensuring the uniform moisture around the seeds, and thereby increasing germination rates.

The term “seed” herein preferably relates to a seed of a crop or plant species including but not limited to corn (Zea mays), Brassica sp. (e.g., B. napus, B. rapa. B. juncea), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Cofea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidental), macadamia (Macadamia integrifolia), almond (Prunus amygdalus), sugar beets (Beta vulgaris), sugarcane (Saccharum spp.), oats, barley, vegetables, ornamentals, woody plants such as conifers and deciduous trees, squash, pumpkin, hemp, zucchini, apple, pear, quince, melon, plum, cherry, peach, nectarine, apricot, strawberry, grape, raspberry, blackberry, soybean, sorghum, sugarcane, rapeseed, clover, carrot, and Arabidopsis thaliana.

In a preferred embodiment, the seed may be of any vegetables species including but not limited to tomatoes (Lycopersicon esculentum), lettuce (e.g., Lactuca sativa), green beans (Phaseolus vulgaris), lima beans (Phaseolus limensis), peas (Lathyrus spp.), cauliflower, broccoli, turnip, radish, spinach, asparagus, onion, garlic, pepper, celery, and members of the genus Cucumis such as cucumber (C. sativus), cantaloupe (C. cantalupensis), and musk melon (C. melo).

In another preferred embodiment, the plant propagation material may be of any ornamental species including but not limited to hydrangea (Macrophylla hydrangea), hibiscus (Hibiscus rosasanensis), petunias (Petunia hybrida), roses (Rosa spp.), azalea (Rhododendron spp.), tulips (Tulipa spp.), daffodils (Narcissus spp.), carnation (Dianthus caryophyllus), poinsettia (Euphorbia pulcherrima), and chrysanthemum.

In one embodiment, the plant propagation material may be of any conifer species including but not limited to conifers pines such as loblolly pine (Pinus taeda), slash pine (Pinus elliotii), ponderosa pine (Pinus ponderosa), lodgepole pine (Pinus contorta), and Monterey pine (Pinus radiata), Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis).

In another preferred embodiment, the seed may be of any leguminous plant species including but not limited beans and peas. Beans include guar, locust bean, fenugreek, soybean, garden beans, cowpea, mungbean, lima bean, fava bean, lentils, chickpea, pea, moth bean, broad bean, kidney bean, lentil, dry bean, etc. Legumes include, but are not limited to, Arachis, e.g., peanuts, Vicia, e.g., crown vetch, hairy vetch, adzuki bean, mung bean, and chickpea, Lupinus, e.g., lupine, trifolium, Phaseolus, e.g., common bean and lima bean, Pisum, e.g., field bean, Melilotus, e.g., clover, Medicago, e.g., alfalfa, Lotus, e.g., trefoil, lens, e.g., lentil, and false indigo. Typical forage and turf grass for use in the methods described herein include but are not limited to alfalfa, orchard grass, tall fescue, perennial ryegrass, creeping bent grass, lucerne, birdsfoot trefoil, clover, stylosanthes species, lotononis bainessii, sainfoin and redtop. Other grass species include barley, wheat, oat, rye, orchard grass, guinea grass, sorghum or turf grass plant.

In another preferred embodiment, the seed may be selected from the following crops or vegetables: corn, wheat, sorghum, soybean, tomato, cauliflower, radish, cabbage, canola, lettuce, rye grass, grass, rice, cotton, sunflower and the like.

It is understood that the term “seed” or “seedling” is not limited to a specific or particular type of species or seed. The term “seed” or “seedling” can refer to seed from a single plant species, a mixture of seed from multiple plant species, or a seed blend from various strains within a plant species. In another preferred embodiment, crop plant propagation materials may include but are not limited to rice, corn, wheat, barley, oats, soybean, cotton, sunflower, alfalfa, sorghum, rapeseed, sugarbeet, tomato, bean, carrot, tobacco or flower seeds, potatoes, sugar cane, ornamental flowers, peppers, watermelon, melon, cucumbers, and in-vitro cell-based multiplications.

Vegetative propagation is the ability of plants to reproduce without sexual reproduction, by producing new, genetically identical, plants from existing vegetative structures. The most common method of artificial vegetative propagation involves removal of parts (commonly referred to as “cuttings”) from the parent plant and placed in a suitable environment where they can grow into a whole new plant. Cutting takes advantage of the ability of plants to form adventitious roots under certain conditions, and the resulting plant is a clone of the parent plant. By plant “parts” is intended all above ground vegetative parts of crop plants such as primary or secondary shoots, leaf, stems, branches, and the like. The methods are useful for any portion of the plant from which adventitious roots can form in the cultivation medium. In some embodiments, the plant part or cutting is a shoot. The shoot can be at least about 1 cm, at least about 2 cm, at least about 3 cm, at least about 5 cm, or larger. The present invention also relates to describes methods for clonally propagating agricultural crop plants, particularly maize, sorghum, wheat, cotton, rice, soybean, sugar-beet, sugarcane, tobacco, barley, and oilseed rape crop plants. In a preferred embodiment, the plants may be clonally propagated in a purely soil based system. In such a system, the root system of the plants must remain in a sufficiently aqueous environment in order to survive and grow roots. Methods useful for the preparation of plant propagation materials may further preferably comprise removing a part (or “cutting”) from a crop plant, such as a primary or secondary shoot or stem, and placing it in a suitable medium sufficient to support the development of one or more roots in the medium. The new plant can then be grown under suitable conditions into a mature plant. Where such cuttings or seedlings are employed, often these are allowed to fall into indentations in the soil prepared prior to the seeding or planting. Seeds on the other hand are usually allowed to fall into furrows, trenches or otherwise prepared plant receiving cavities, which are then usually closed up after sowing to prevent loss of the seeds due to e.g. wind or animals.

As used herein, the term “dressing composition” herein relates to liquid compositions useful for covering and/or wetting a seed or plant material at least in part. Such compositions comprise at least one agricultural compound, and a diluent, solvent or otherwise carrier permitting an application. This “dressing composition”, also referred to herein as “dressing” or “seed dressing”, relates to a substance formulation which is a liquid or a gel, and of such a and which contains active agricultural compounds, and additionally may also contain other components, such as fillers, diluents, solvents, adhesive agents, dispersants, stabilizers, emulsifiers and colouring agents. In some embodiments, the dressing may be an adhesive powder.

The liquid seed dressing composition used in the present invention may comprise a liquid diluent material and one or more agricultural compounds. The activity of compositions comprising agricultural compounds according to the invention may be adapted to prevailing circumstances, by including other active substances.

As used herein, the term “agricultural compound” or “active compound” or “active ingredient” herein relates to compounds such as those biocidal, growth-promoting or growth-regulating, or other biological effects, i.e. compounds and substances known to assist the growth of crops, comprising chemical or biological substances including but not limited to micronutrients, insecticides, for protecting against sucking and eating insects; fungicides for protecting against fungal pathogens; inoculants, antibacterials, herbicides, acaricides, nematicides; virostatics for inactivating viruses; safeners; immune-response-triggering compounds; biologicals, biosimilars, gene modulating seed dressings; growth regulators; and crop enhancers that offer specific, chemically induced, physiological responses of plants that increase and/or improve yields, in particular under abiotic stress; as well as diluents, solvents, carriers, emulsifiers, viscosity modifiers, stabilizers, encapsulants and/or any colorants, and any combinations thereof. Preferred micronutrients include Zinc, Molybdenum, Manganese, Magnesium, Boron, Copper, Iron, Nickel, and Chlorine.

The dressing composition may be applied at application stage, which herein relates to the viscosity and concentration that allows application as a fluid to a plant propagation material.

List of reference signs and symbols

| | |
|---|---|
| 100 | sowing device |
| 110 | reservoir container (seed tank) |
| 120 | separation device |
| 130 | application device |
| 200 | application unit |
| 210 | seed tube |
| 210a | lower end (releasing end) |
| 210b | mounting bay |
| 210c | upper end (receiving end) |
| 210d | sensor mounting area |
| 220 | application functional block |
| 230 | interface unit |
| 240 | application supply line |
| 242 | electric control cabling |
| 250 | supply unit |
| 262 | electric cabling |
| 264 | pneumatic supply line |
| 300 | seed tube sub-controller |
| 310 | first sensor arrangement |
| 312, 312′ | upper, lower sensor array |
| 314 | sensor casing |
| 316 | seed detection sensor |
| 318 | seed sensor control line |
| 330 | applicator device |
| 332 | application nozzle |
| 334 | application shutoff valve |
| 336 | applicator control line |
| 350 | pressure sensor |
| 352 | pressure sensor control line |
| 370 | second sensor arrangement |
| 372 | feedback sensor |
| 374 | feedback sensor control line |
| 410 | seed tube event series |
| 430 | control logic |
| 450 | feedback logic |
| 500 | main body |
| 502, 502′ | side walls |
| 504 | front wall |
| 506 | back wall |
| 510, 512 | mounting elements |
| 514 | mounting bore |
| 516 | recess |
| 518 | socket |
| 520 | bore |
| 522 | mounting bore |
| 524 | ramp |
| 530 | lower part |
| 540 | upper part |
| A | scan zone |
| B | underlying surface |
| D | droplet (aliquot) |
| E | detection zone |
| I | impact location |
| K | plant propagation material |
| S412, S414, . . . | procedural steps |
| T | hit zone |
| b | width |
| dₛ | distance |
| f | fall line |
| j | spraying trajectory |
| t1, t2 | seed passing time |
| ta | application time (trigger time) |
| tf | flying time |
| tfs | feedback sensor passing |
| v | velocity of movement |
| Δta | time shift |
| α | acute angle |
| β | sensor angle |

1. A method for applying a dressing composition to plant propagation materials, preferably seed, in particular granular seed, preferably singulated by and released from a separating means of a sowing device and falling to an underlying surface, the method including:
detecting, by means of a first sensor arrangement, a plant propagation material which is freely falling within a predetermined detection zone;
determining, based on the detecting the plant propagation material, a trigger time for triggering a triggerable applicator device provided for discharging aliquots of the dressing composition towards a predetermined hit zone where the plant propagation material can be hit in free fall by the aliquots, the hit zone being preferably defined by a spraying trajectory of the dressing composition discharged from the applicator device;
triggering the triggerable applicator device at the determined trigger time (ta) to discharge an aliquot of the dressing composition towards the hit zone;
scanning, by means of a second sensor arrangement, a predetermined scan zone where the plant propagation material is in free fall, within or around or after the hit zone;
judging, based on a result of the scanning, whether or not the plant propagation material was hit by the aliquot, the result of the scanning preferably being a distance information.

2. The method of claim 1, wherein the method further includes:
if the judging reveals that the plant propagation material was not hit by the aliquot: adapting a parameter used in determining a trigger time (ta) for a next plant propagation material.

3. The method of claim 2, wherein the determining the trigger time (ta) includes:
determining a time shift (Δta) from detection of the plant propagation material until application of the dressing composition; and
calculating the trigger time (ta) as a sum of the time of detection and the time shift (Δta) while applying a further variable addend and/or a variable factor by which the time shift (Δta) or a monomial of a polynomial representing the time shift (Δta) is multiplied, wherein the parameter includes the variable addend and/or the variable factor,
wherein the determining the time shift (Δta) preferably includes at least one of:
determining a drop time of the plant propagation material from its detection until it arrives at the hit zone,
determining a flying time (tf) of the aliquot from its discharge by the applicator device until it arrives at the hit zone,
calculating the time shift (Δta) by including the drop time and/or the flying time (tf) as addends, wherein the parameter preferably includes a variable factor by which the drop time and/or the flying time (tf) or a monomial of a respective polynomial representing the drop time or flying time (tf) are multiplied.

4. The method of claim 3, wherein the determining the time shift (Δta) includes determining a drop time of the plant propagation material from its detection until it arrives at the hit zone, and the determining the drop time includes:
determining a drop velocity of the detected plant propagation material; and
calculating the drop time of the plant propagation material based on the drop velocity and a distance between the detection zone and the hit zone,
wherein preferably:
the detecting the plant propagation material includes detecting a first passing time (t1) of the plant propagation material passing a first location within the detection area, and detecting a second passing time (t2) of the plant propagation material passing a second location within the detection area, the second location being located downstream the first location along a falling direction of the plant propagation material, the first location and the second location preferably being cross-sectional areas or diameters across the falling direction of the plant propagation material; and
the drop velocity of the detected plant propagation material is calculated based on the first passing time and the second passing time and a distance (dₛ) between the first location and the second location.

5. The method of claim 3, wherein the determining the time shift (Δta) includes determining a flying time (tf) of the aliquot from its discharge by the applicator device until it arrives at the hit zone, and the determining the flying time (tf) includes:
determining a shot velocity of an aliquot of dressing composition discharged from the applicator device; and
calculating the flying time (tf) of the aliquot based on the shot velocity and a distance between a discharge opening of the applicator device and the hit zone,
wherein preferably:
the detecting the plant propagation material includes detecting an offset of the plant propagation material detected in the detection zone; and
the determining the flying time includes calculating a predicted impact location of the plant propagation material within the hit zone based on the detected offset in the detection zone, and calculating the flying time (tf) based on the shot velocity and a distance between a discharge opening of the applicator device and the predicted impact location.

6. The method of claim 2, wherein the judging includes:
determining a predicted time of hit or a predicted location of the plant propagation material after a hit as an expected result of scanning;
determining an detected time of hit or a detected location of the plant propagation material after a hit as an actual result of scanning, by evaluating the result of the scanning;
comparing the predicted time of hit with the detected time of hit, or the predicted location of the plant propagation material after a hit with the detected location of the plant propagation material after a hit as an actual result of scanning, to obtain a difference between the expected result of scanning and the actual result of scanning.

7. The method of claim 2, wherein the adapting includes:
statistically evaluating differences between expected results of scanning and actual results of scanning for a plurality of plant propagation material or over a predetermined time, and
deciding, based on the statistical evaluation, whether or not a significant shift has occurred; and
if the deciding is made to the affirmative, adapting the parameter, otherwise not.

8. The method of claim 2, wherein the method includes machine learning, in particular for the adapting the parameter in the determining the trigger time (ta).

9. The method of claim 1, further including:
detecting whether or not the applicator device was actually triggered at the determined trigger time (ta), and/or whether or not an appropriate aliquot of dressing composition was actually discharged after triggering; and
suppressing the scanning the scan zone and judging if it is detected that the applicator device was not triggered at the determined trigger time (ta), and/or an appropriate aliquot of dressing composition was not discharged after triggering.

10. The method of claim 1, wherein plural seed detection sensors covering the detection zone are controlled in a serial fashion such that cross-detection may be avoided.

11. An application unit for applying a dressing composition to a plant propagation material, preferably seed, in particular granular seed, falling during sowing, the application unit being formed to be mounted with a sowing device having separating means for singulating plant propagation materials supplied from a reservoir container and releasing the singulated individual plant propagation materials to free fall, the application unit comprising:
a seed tube defining a falling space for plant propagation material, being formed to receive plant propagation materials from the separating means, allow each plant propagation material to fall through the falling space while optionally being guided by walls of the seed tube, and to further fall onto an underlying surface after leaving the seed tube;
a first sensor arrangement formed and arranged for detecting a plant propagation material falling within a predetermined detection zone within the falling space;
a triggerable applicator device formed and arranged for discharging an aliquot of a dressing composition received from a dressing composition supply, the applicator device having a discharge opening directed to a hit zone which is defined by an intersection of a spraying trajectory (j) of dressing composition discharged from the applicator device with the falling space to hit the plant propagation material in free fall, the hit zone preferably being outside the seed tube, the applicator device having a triggerable application valve for opening or closing a fluid communication with the dressing composition supply;
a second sensor arrangement formed and arranged for scanning a predetermined scan zone where the plant propagation material is in free fall, within or around or after the hit zone in a falling direction of the plant propagation material; and
a control unit configured for controlling the first sensor arrangement to detect a plant propagation material falling within the detection zone and receiving output signals from the first sensor arrangement, determining a trigger time (ta) based on a detection time of the detected plant propagation material, triggering the applicator device to open the fluid communication path at the determined trigger time (ta) for a predetermined open time to discharge an aliquot of the dressing composition towards the hit zone, controlling the second sensor arrangement to scan the scan zone after triggering the applicator device, and judging, based on output signals received from the second sensor arrangement, whether or not the plant propagation material was hit or sufficiently hit by the aliquot.

12. The application unit of claim 11, wherein the first sensor arrangement includes a first sensor array of one or more seed detection sensors covering a first location within the detection zone and a second sensor array of one or more seed detection sensors covering a second sensor area within the detection zone, the second location being located downstream the first location along a falling direction of the plant propagation material, the first location and the second location preferably being cross-sectional areas or diameters across a longitudinal axis of the seed tube.

13. The application unit of claim 11, wherein each seed detection sensor in the first sensor arrangement includes a laser light barrier, and the control unit is preferably adapted to control the seed detection sensors in the first sensor arrangement in a serial fashion.

14. The application unit of claim 11, wherein the second sensor arrangement includes a feedback sensor, in particular a distance sensor, preferably an ultrasonic distance sensor, and the control unit is adapted to determine a presence and/or distance of the plant propagation material based on sensor signals received from the second sensor arrangement, and to judge based on the determined presence and/or distance of the plant propagation material whether or not the plant propagation material detected before by means of the first sensor arrangement was hit by the aliquot.

15. The application unit of claim 11, further including an valve operation sensor formed and arranged for detecting an operating state of the application valve and/or a pressure sensor formed and arranged for detecting a fluid pressure of a fluid supply line for supplying the dressing composition to the applicator device, wherein the control unit is preferably adapted to judge, based on sensor signals received from the valve operation sensor, whether or not the applicator device was actually triggered at the determined trigger time (ta), and/or to judge, based on sensor signals received from the pressure sensor, whether or not an appropriate aliquot of dressing composition was actually discharged after triggering, and in either negative case to skip the scanning and judging based thereon.

16. An application unit, wherein a control unit is formed and configured for controlling elements of the application unit and/or equipment external from the application unit to perform the method of claim 1.

17. A seed tube, in particular in the application unit of claim 11, having a body for defining a falling space for plant propagation material, preferably seed, in particular granular seed, the body having a receiving end with a receiving opening for receiving plant propagation materials from a separation means of a sowing device and a releasing end for releasing the plant propagation materials after having fallen through the falling space, the body further having first sensor mounting means for mounting a first sensor arrangement to cover a detection zone defined within the falling space, in particular within the internal space of the body, applicator mounting means for mounting an applicator device to have a supply end to be connected to a fluid supply line and a discharge opening directed to a hit zone defined within the falling space and preferably outside the internal space of the body-beyond the releasing end thereof, the body further comprising:
second sensor mounting means for mounting a second sensor arrangement to cover a scan zone defined within or around or after the hit zone in a falling direction of the plant propagation material; and/or
electronics mounting means for mounting a control unit for controlling the first sensor arrangement and/or the applicator device and/or the second sensor arrangement.

18. The seed tube of claim 17, further comprising a guiding channel formed by the body between and including the detection zone and the releasing end, the guiding channel having a width (b) at least in one cross-sectional direction which is adapted to a grain size of a particular type of plant propagation material.

19. A dressing application device having a plurality of application units each according to claim 11, wherein at least part of a control unit of each application unit is provided in a distributed fashion in each application unit, in particular mounted to a respective seed tube of each application unit, and the dressing application device having at least one of:
a power supply;
a dressing reservoir for fluidized dressing composition; and
piping for communicating respective applicator devices of each application unit with the dressing reservoir.

20. A sowing device having a reservoir container for carrying plant propagation materials, preferably seed, in particular granular seed, separating means for singulating plant propagation materials of from the reservoir container and releasing the plant propagation materials to allow the plant propagation materials to fall onto an underlying surface, one of more of application units each according to claim 11, each application unit being formed and mounted to receive plant propagation materials released from the separating means at a receiving end of a respective seed tube.
